(19) United States
(12) Patent Application Publication
(10) Pub. No.: US 2026/0346438 A1
(43) Pub. Date: Nov. 5, 2026

(54) WI-FI ACCESS POINT-BASED SHARED WORLD MODEL FOR PHYSICAL ARTIFICIAL INTELLIGENCE

(71) Applicant: Dorian Cartwright, San Jose, CA (US)

(72) Inventor: Dorian Cartwright, San Jose, CA (US)

(21) Appl. No.: 19/743,563

(22) Filed: Jul. 16, 2026

Related U.S. Application Data
(63) Continuation-in-part of application No. 19/654,952, filed on Apr. 22, 2026.
(63) Continuation-in-part of application No. 19/654,785, filed on Apr. 22, 2026.
(63) Continuation-in-part of application No. 19/640,711, filed on Apr. 7, 2026.
Application No. 19/640,711 is a continuation of application No. 19/638,074, filed on Apr. 2, 2026.

(51) Int. Cl. B25J 9/16

(52) U.S. Cl. CPC B25J 9/163; B25J 9/1661; B25J 9/1694

(57) ABSTRACT

A Wi-Fi runtime operating system provides network-resident services to heterogeneous physical artificial intelligence systems. Wi-Fi infrastructure detects a connected device, classifies it as a physical AI system using association information, credentials, metadata, traffic behavior, or protocol characteristics, and selects runtime services from a physical-AI service registry. Services may include shared world state, hazards, occupancy, reservations, identity, trust, enterprise policy, protocol translation, physical-risk quality of service, localization, and telemetry. An access point maintains location-scoped physical state and physical-space reservations for a corresponding coverage region, while a wireless controller manages enterprise policy and roaming continuity. Enterprise Wi-Fi thereby functions as a runtime platform for discovering, onboarding, coordinating, and governing physical AI systems while preserving local motion and actuator control.

### CROSS-REFERENCE TO RELATED APPLICATIONS

This application is a continuation-in-part of commonly owned: U.S. patent application Ser. No. 19/640,711 filed Apr. 7, 2026, entitled PREDICTIVE ACTUATION GATING FOR A HETEROGENEOUS PHYSICAL ARTIFICIAL INTELLIGENCE SWARM; U.S. patent application Ser. No. 19/654,785, filed Apr. 22, 2026, entitled DECENTRALIZED STORAGE-SLOT RESERVATION IN A HETEROGENEOUS PHYSICAL ARTIFICIAL INTELLIGENCE (AI) SWARM; U.S. patent application Ser. No. 19/654,952, filed Apr. 22, 2026, entitled DECENTRALIZED ENCOUNTER-BASED SHARING OF SEMANTIC HAZARD DATA IN A HETEROGENEOUS PHYSICAL ARTIFICIAL INTELLIGENCE (AI) SWARM; and U.S. patent application Ser. No. 19/654,808, filed Apr. 22, 2026, entitled DECENTRALIZED LOAD-SHARING AND POSITIONAL COORDINATION IN A HETEROGENEOUS PHYSICAL ARTIFICIAL INTELLIGENCE (AI) SWARM, the entire disclosures of each being incorporated herein by reference in their entireties.

### FIELD OF THE INVENTION

The present disclosure relates generally to computers and artificial intelligence, and more specifically, to a Wi-Fi access point-based shared world model for physical artificial intelligence.

### BACKGROUND

Wi-Fi infrastructure conventionally provides connectivity between endpoint devices and local or remote computing resources. An access point commonly performs association, authentication support, packet forwarding, radio-resource management, and quality-of-service treatment. A wireless controller may configure multiple access points, enforce enterprise network policy, coordinate roaming, maintain device inventories, and provide network analytics. These functions generally treat connected devices as computing or communication endpoints rather than as machines capable of causing physical motion in a shared environment.

Physical artificial intelligence systems increasingly include humanoid robots, autonomous mobile robots, robotic arms, drones, vehicles, mobile manipulators, automated forklifts, inspection devices, and infrastructure-coupled machines. Such systems may enter factories, hospitals, warehouses, airports, campuses, retail facilities, offices, and public spaces while using different manufacturers, operating systems, fleet-management platforms, communication protocols, semantic models, and control architectures. Conventional enterprise networks provide these systems with data connectivity but do not ordinarily provide a common runtime environment for their physical operation.

Existing robot fleet managers are usually implemented as separate application servers associated with a particular vendor or administrative fleet. A mixed deployment may therefore require separate fleet servers, adapters, dashboards, and policy systems. These systems often lack a network-native mechanism for automatically identifying a newly connected robot, determining what robot protocols or server resources it uses, and assigning a corresponding physical-AI runtime profile without manual onboarding.

A further problem is that important operational state is often local to individual robots or application servers. A newly entering robot may have no immediate knowledge of a spill, stalled robot, occupied corridor, reserved loading dock, human-priority zone, elevator condition, charger availability, or temporary speed restriction. The robot must reconstruct relevant conditions from its own sensors or wait for a proprietary fleet server. This delay can impair safety and efficiency.

Access points are physically distributed throughout an enterprise and commonly correspond to bounded wireless coverage regions. However, conventional access points do not treat their coverage regions as managed physical cells. They do not ordinarily maintain local danger state, physical occupancy, time-and-volume reservations, robot intentions, or local robot-service descriptors for delivery to machines associating within the coverage region.

Wireless controllers similarly apply enterprise policy to network use but not to physical robot operation. Network access rules may govern addresses, ports, bandwidth, or application categories while failing to express that a robot may enter one work area but not another, may carry a payload only below a speed threshold, may publish hazard observations but not authoritative infrastructure state, or may use a physical resource only during a reserved interval.

Manual identification is also a bottleneck. A robot may expose information through association metadata, certificates, DHCP behavior, service advertisements, transport protocols, destination servers, topic names, packet sizes, timing patterns, or encrypted-traffic characteristics. Conventional network systems may classify general device or application types, but do not use such observations to instantiate robot-specific runtime services, shared-state access, physical-operation policies, protocol translation, or trust treatment.

Accordingly, there exists a need for a robust Wi-Fi access point-based shared world model for physical artificial intelligence.

### SUMMARY

The present disclosure provides systems, methods, and computer program products for a Wi-Fi runtime operating system for physical artificial intelligence. The runtime may be implemented in one or more wireless access points, wireless controllers, edge servers, premises servers, cloud or software-as-a-service platforms, or combinations thereof.

In one embodiment, a physical-AI discovery service detects a wireless device associating with or communicating through a Wi-Fi network. A classification service determines that the device is a robot or other physical AI system and identifies one or more device, protocol, capability, mission, or server-resource characteristics based on association data, identity credentials, packet metadata, packet content, service-discovery information, traffic behavior, destination information, encrypted-flow characteristics, or combinations thereof.

Responsive to the classification, a runtime manager selects a physical-AI runtime profile and provides one or more network-resident services to the physical AI system. The services may include discovery, identity, authentication, shared-state, hazard, occupancy, reservation, policy, trust, protocol translation, quality of service, localization, time synchronization, firmware, telemetry, inference, infrastructure discovery, or service-registry functions.

In some embodiments, an access point maintains a local physical-state model for a wireless coverage region. The local model may include hazard objects, occupancy objects, reservation objects, infrastructure objects, human-priority areas, robot intentions, or predicted trajectories. A newly associated robot receives a permissioned state view and may publish updates while operating in the region. The access point may operate as a local micro-planner by resolving physical-space conflicts, allocating time-dependent occupancy rights, or distributing local route constraints.

In some embodiments, a wireless controller provides enterprise-level physical-AI policy. The controller may maintain robot identities, roles, trust states, allowed service classes, physical operating zones, speed and force constraints, infrastructure permissions, software profiles, quality-of-service policies, and roaming state across multiple access points.

In some embodiments, the runtime derives a physical-risk communication treatment based on a current or planned physical operation. Traffic associated with emergency stopping, balance, shared-load support, collision avoidance, occupancy revocation, or another safety-critical function may receive a different transmission priority, reliability treatment, scheduling treatment, or redundancy level than background mapping, analytics, or software distribution.

In some embodiments, the runtime preserves a physical-AI session while a robot roams between access points. The runtime changes a location-dependent state view, transfers or reassigns reservations, preserves identity and trust context, and applies a policy associated with the new coverage region.

In some embodiments, the access point continues local fleet services during loss of connectivity to a controller. The access point may enter a local continuity or lockdown mode, maintain existing reservations and hazards from a local state store, restrict admission of new robots, log updates, and reconcile state when controller connectivity is restored.

Advantageously, the disclosed platform permits enterprise Wi-Fi to function as an operating environment for heterogeneous physical AI services. Robots may retain local stabilization, planning, validation, and actuator control while obtaining shared premises state, network-derived identity, physical-space coordination, and enterprise policy from the Wi-Fi runtime operating system.

Many other variations are possible.

### BRIEF DESCRIPTION OF THE DRAWINGS

FIG. 1 is a block diagram illustrating an overall Wi-Fi runtime operating system for physical artificial intelligence, including heterogeneous physical AI systems, Wi-Fi access points, a wireless controller, an edge service, and a cloud or software-as-a-service platform, according to an embodiment.

FIG. 2 is a more detailed block diagram illustrating runtime services of the Wi-Fi runtime operating system, including robot discovery, identity, authentication, shared-state, hazard, occupancy, reservation, enterprise-policy, trust, protocol-translation, physical-risk quality-of-service, software-distribution, telemetry, localization, time-synchronization, and service-registry services, according to an embodiment.

FIG. 3 is a block diagram illustrating an access-point-local physical cell in which an access point maintains hazards, occupancy, reservations, robot intentions, and local route constraints for robots operating within a wireless coverage region, according to an embodiment.

FIG. 4 is a sequence diagram illustrating wireless association, robot identification from wireless information, runtime-profile selection, service discovery, state delivery, state publication, policy assignment, and physical operation, according to an embodiment.

FIG. 5 is a block diagram illustrating a computing environment for implementing the Wi-Fi runtime operating system, according to an embodiment.

FIG. 6 is a flow chart illustrating an overall method for identifying and onboarding a physical AI system into a Wi-Fi runtime operating domain, according to an embodiment.

FIG. 7 is a flow chart illustrating a method for maintaining access-point-local physical state and physical-space reservations, according to an embodiment.

FIG. 8 is a flow chart illustrating a method for applying enterprise physical-AI policy and physical-risk-aware communication treatment while a robot roams among access points, according to an embodiment.

### DETAILED DESCRIPTION

The following description provides systems, methods, and computer program products for a Wi-Fi runtime operating system for physical artificial intelligence devices within RF range. The embodiments are illustrative and not limiting, for example, Wi-Fi is used throughout in detail, although the same principles can be applied to Bluetooth and other communication channels. Features described with respect to one embodiment may be combined with features of other embodiments unless context indicates otherwise.

As used herein, a physical artificial intelligence system includes a physically embodied or infrastructure-coupled system that senses, predicts, plans, controls, or affects a physical environment. Examples include humanoid robots, autonomous mobile robots, robotic arms, mobile manipulators, drones, autonomous vehicles, automated forklifts, quadruped robots, service robots, industrial machines, smart doors, elevators, chargers, conveyors, and other cyber-physical systems.

As used herein, Wi-Fi includes wireless local area networking based on an IEEE 802.11 family protocol or a successor or compatible wireless local networking protocol. References to an access point or wireless controller are functional and include physical, virtualized, distributed, cloud-managed, software-defined, embedded, or combined implementations.

### I. Systems

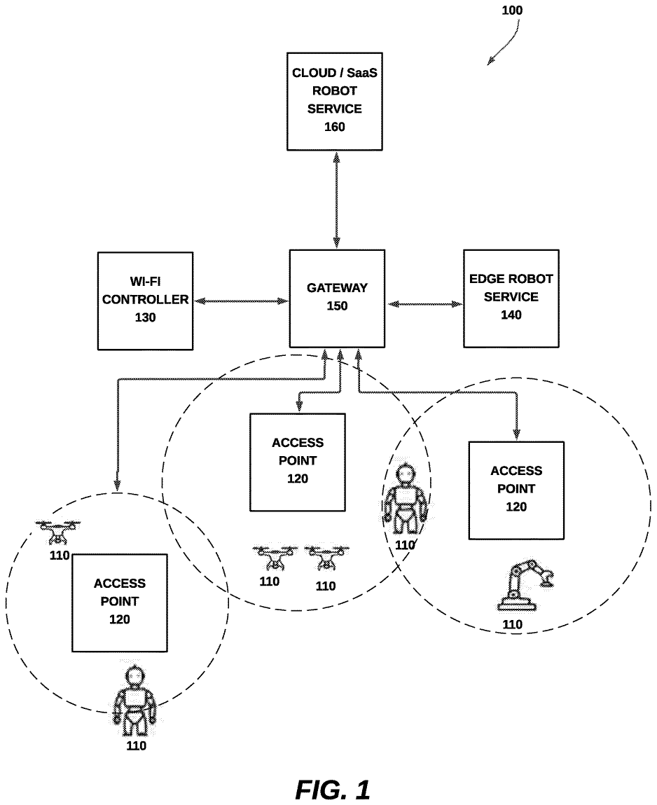

### A. Overall Wi-Fi Runtime Operating System Architecture (FIG. 1)

FIG. 1 illustrates a Wi-Fi physical-AI environment 100 including heterogeneous physical AI systems 110A-110N, one or more Wi-Fi access points 120A-120N, a wireless controller 130, a premises edge system 140, a gateway 150, a cloud or software-as-a-service platform 160, and one or more physical environments. The access points, controller, edge system, and cloud platform collectively implement a Wi-Fi runtime operating system.

The physical AI systems 110 may include systems from different manufacturers, owners, administrative authorities, operating systems, fleet platforms, form factors, sizes, native software stacks, or protocol families. A physical AI system may execute a local robot operating system, a motion planner, a vision-language-action model, a world model, a mission planner, a predictive validator, an actuator firewall, low-level controllers, or combinations thereof. The Wi-Fi runtime operating system does not require replacement of the local robot operating system.

Each access point 120 may define or be associated with a physical coverage cell 162. The physical coverage cell may correspond to an RF range, aisle, room, workcell, corridor, loading area, floor section, elevator approach, hospital wing, airport gate, retail zone, sidewalk segment, or another bounded or partially bounded region. The association between radio coverage and physical space may be determined from deployment records, access-point location, ranging measurements, signal maps, building information models, surveys, or dynamic localization.

The wireless controller 130, as a higher layer of abstraction services, may manage multiple access points and provide enterprise-wide robot identity, policy, roaming, state synchronization, protocol profiles, security, service assignment, and quality-of-service treatment. The premises edge system 140 may provide higher-compute services, state persistence, multi-cell planning, analytics, local inference, protocol gateways, and operation during cloud unavailability. The cloud platform 150 may provide cross-site identity, policy distribution, software packages, historical state, analytics, trust reputation, digital-twin synchronization, and remote administration.

The Wi-Fi runtime operating system may expose a service descriptor to a physical AI system. The descriptor can identify a premises, runtime domain, service registry, supported protocols, available services, authentication requirements, schema versions, coordinate frames, time bases, policy profiles, trust requirements, software or adapter packages, and communication endpoints. The descriptor may be delivered before association, in a beacon, during association, during authentication, through network configuration, by local service discovery, or after an application-layer handshake.

A physical AI system 110 may participate through a local runtime agent. The agent may be preinstalled, downloaded, activated from a dormant module, executed in a container, implemented as a middleware bridge, or provided by a browser-like or WebAssembly runtime. The agent can discover services, translate between local and network schemas, publish permitted state, receive permissioned state views, apply local policy, and preserve provenance of network-supplied information.

The runtime may serve a robot that is not a member of any enterprise fleet. A contractor robot, delivery robot, visiting humanoid, autonomous vehicle, or inspection drone may join temporarily, receive a restricted runtime profile, publish only authorized state classes, and lose access when leaving the premises or when credentials expire.

Network-resident services may operate in advisory, planning, validation, or enforcement roles. For example, a local hazard service may merely advise a robot of a wet floor. An occupancy service may constrain route planning. An enterprise policy service may require a local prediction validator to apply a maximum speed. A downstream actuator firewall may independently decide whether a candidate action is permitted.

In some embodiments, the Wi-Fi runtime operating system provides service contracts rather than direct motor commands. Robots retain local stabilization and actuator control, while the network provides shared state, physical rights, policies, coordination data, and service discovery. In other embodiments, the runtime may provide higher-level waypoints, task assignments, reservations, or validated execution envelopes, subject to local acceptance and validation.

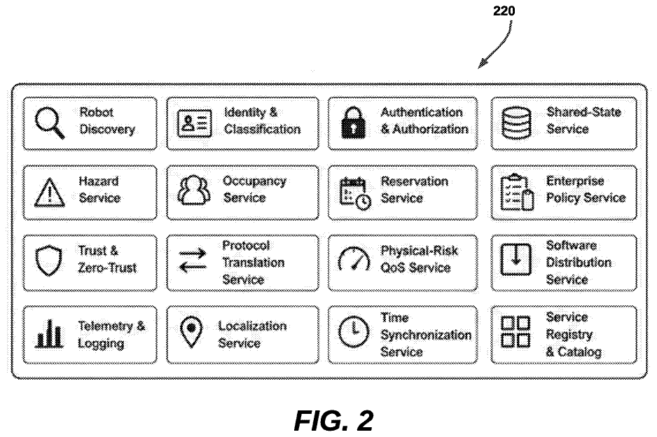

### B. Runtime Services and Service Registry (FIG. 2)

FIG. 2 illustrates a Wi-Fi runtime operating system 200 including a runtime manager 205, physical-AI service registry 210, robot discovery service 220, robot identity and classification service 230, authentication and trust service 240, shared-state service 250, local hazard service 260, occupancy and reservation service 270, enterprise policy service 280, protocol translation service 290, physical-risk quality-of-service service 300, software and firmware service 310, telemetry and audit service 320, localization and time service 330, and one or more additional services 340. In one example, service availability is based on network security permissions of a user, device, or application.

The service registry 210 maintains descriptors of available physical-AI services. A descriptor may include a service identifier, service type, endpoint, version, supported robot classes, schema, authorization requirements, location scope, latency class, reliability class, data-retention policy, trust level, and dependency information. Services may be instantiated persistently, on demand, per robot, per access point, per mission, or per physical region.

The robot discovery service 220 detects association, pre-association queries, service-discovery messages, network flows, presence in a radio cell, or another indication that a physical AI system is available. Discovery can be active or passive. The service may request a capability descriptor or infer capabilities without requiring a preconfigured robot account.

The robot identity and classification service 230 analyzes one or more wireless or network observations. Example inputs include a MAC address or organizational identifier, device certificate, authentication identity, DHCP fingerprint, hostname, parameter-request list, service advertisement, multicast discovery, transport protocol, destination address, domain-name request, server endpoint, packet size distribution, timing pattern, topic or message identifier, application payload, encrypted-flow characteristic, radio movement pattern, or prior device history.

The classification service may determine that a device is a humanoid, mobile robot, drone, vehicle, robotic arm, industrial controller, or other physical AI system. It may identify a manufacturer, model family, operating system, fleet protocol, messaging protocol, supported state classes, actuation risk class, mission type, or required server resource. A classification may include a confidence score and may trigger a request for explicit confirmation.

Responsive to classification, the runtime manager 205 selects a runtime profile. The profile may determine which services are exposed, which network segments are reachable, what bandwidth is allocated, what state can be published or consumed, what physical regions are permitted, which protocol adapter is activated, and whether the robot operates in ordinary, restricted, quarantine, observation-only, or emergency mode.

The authentication and trust service 240 verifies device, owner, operator, manufacturer, software, hardware, or premises credentials. Trust may be state-class specific. A robot may be trusted to report its own battery level but not to publish authoritative elevator state. A building controller may be authoritative for a door position, while a visiting robot may provide only an advisory visual observation.

The shared-state service 250 maintains one or more typed state models. State classes may include ObjectState, HumanState, RobotState, InfrastructureState, HazardState, OccupancyState, ReservationState, CapabilityState, MissionState, TaskState, PolicyState, ChargingState, TrafficState, WeatherState, IntentionState, PredictionState, and DigitalTwinState. State may be scoped by access point, building, campus, enterprise, or cloud tenancy.

The hazard service 260 maintains local danger and exclusion state. A hazard object may identify a region, object, semantic condition, severity, confidence, source, observation time, validity interval, recommended speed, prohibited operation, or required verification. Hazard state can be published by robots, cameras, building sensors, human operators, or external systems.

The occupancy and reservation service 270 maintains physical-space use. Occupancy may identify present or predicted physical presence. A reservation may define a region, three-dimensional volume, trajectory corridor, workcell, charger, loading dock, elevator, shelf, tool, or other physical resource, together with a time interval, holder, priority, required clearance, expiration condition, and release condition.

The enterprise policy service 280 maintains policies applicable to robot identity, location, role, mission, payload, time, trust, or state. A policy may define permitted regions, maximum speed, maximum force, required human clearance, infrastructure access, allowed service classes, data publication rights, local-verification requirements, supervision requirements, or emergency behavior.

The protocol translation service 290 maps among vendor-specific robot protocols, topic structures, APIs, schemas, coordinate frames, units, and semantic ontologies. The service may execute as a gateway, proxy, adapter, sidecar, container, plugin, or translation pipeline. A selected adapter may be downloaded or instantiated automatically based on the identified robot profile.

The physical-risk quality-of-service service 300 selects communication treatment based on physical consequence. Inputs may include traffic type, candidate action, control deadline, velocity, payload, human proximity, cooperative-task status, balance state, emergency state, and consequence of loss or delay. Output treatment may include queue selection, scheduling priority, airtime allocation, redundancy, retransmission, latency target, bounded staleness, multicast treatment, unicast treatment, or reserved transmission opportunity.

The software and firmware service 310 provides signed packages, adapters, policies, maps, model updates, firmware, runtime modules, or configuration. Distribution may be unicast, multicast, broadcast, peer-assisted, cached at access points, staged by the controller, or scheduled during low-load periods.

The telemetry and audit service 320 records association, identity, classification, policy, state publication, reservation, service use, quality-of-service assignment, roaming, disconnection, and physical-operation events. Logs may preserve which network-supplied state or policy influenced a robot operation without necessarily retaining private raw sensor data.

The localization and time service 330 may derive location from access-point association, signal measurements, round-trip timing, angle, ultra-wideband, external positioning, building coordinates, robot-reported pose, or combinations thereof. It may provide a premises coordinate frame and synchronized time used to compare occupancy, reservations, trajectories, and state validity.

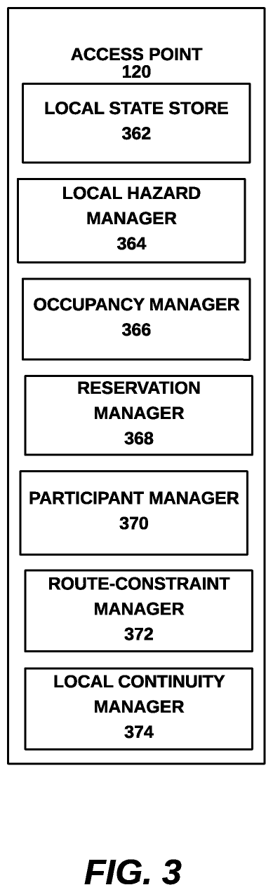

### C. Access Point-Local Physical Cell and Physical Rights (FIG. 3)

FIG. 3 illustrates an access point 120 associated with a local physical cell 360. The access point includes or communicates with a local state store 362, local hazard manager 364, occupancy manager 366, reservation manager 368, participant manager 370, route-constraint manager 372, and local continuity manager 374.

The local state store 362 may maintain a compact state slice relevant to the physical cell. State can include fixed geometry, dynamic obstructions, people, robots, infrastructure, doors, elevators, chargers, tool stations, spills, congestion, no-go regions, and temporary operating constraints. The state slice may be synchronized with a controller or edge service but remains locally accessible for low-latency operation.

The hazard manager 364 may receive state from a robot or sensor, normalize the state, assign a local validity interval, and notify subscribers. A newly associating robot may receive active hazards before moving substantially into the cell. The manager may increase confidence when multiple sources corroborate a hazard and decrease confidence or expire the hazard when observations become stale.

The occupancy manager 366 may maintain actual and predicted occupancy for robots and other actors. A robot may publish a current pose, swept volume, intended route, speed envelope, or confidence. The manager may derive occupancy from network location, infrastructure sensors, or observations from other participants.

The reservation manager 368 treats physical space and resources as allocable rights. A reservation may provide a robot with a temporary right to occupy a corridor volume, enter an intersection, use a charger, access a loading dock, approach an elevator, operate a manipulator in a workcell, or use another constrained resource. The manager may detect temporal and geometric conflict, assign priority, propose an alternative time or region, and revoke a reservation when its conditions are not satisfied.

In one embodiment, a robot requests a path slot defined by a corridor or volume and a time interval. The access point grants a lease and publishes the granted reservation to other participants. If the robot fails to enter, misses a heartbeat, disconnects, exceeds the interval, or leaves the region, the reservation is released or reassigned. Reservation state may be coordinated with adjacent access points for routes that cross multiple cells.

The participant manager 370 maintains the identity, capabilities, trust, and current presence of physical AI systems in the cell. It may distinguish an actively associated robot, a robot detected through passive traffic observation, a robot represented by another access point, and a robot predicted to arrive.

The route-constraint manager 372 may distribute virtual waypoints, speed regions, local exclusions, approach sequences, or recommended path changes. Such outputs need not directly command motors. They may be provided as constraints or proposals to the robot's local planner and predictive validator (e.g., TrustBoundary™ by TrustRobotics™).

The access point may maintain local physical rights independently of radio airtime rights. A robot can have permission to communicate while lacking permission to enter a physical region. Conversely, a robot may hold a physical reservation while temporarily using another access point. The runtime links, but does not conflate, network connectivity, service permission, and physical-space authorization.

An access point may provide multiple service levels. A known enterprise robot may receive full state and reservation services. A known security robot may be given high permissions than a known kitchen robot. Also, a visiting delivery robot may receive a limited route and hazard view. Finally, an unidentified device may be quarantined, restricted to an onboarding service, or prevented from publishing state capable of influencing other robots.

The local continuity manager 374 responds to loss of connectivity with a controller or edge system. The access point may preserve existing participants and reservations, stop accepting new reservations, apply cached safety policy, append updates to a local log, and reconcile versions after reconnection. If a robot disconnects, the manager may mark its occupancy uncertain, preserve a conservative region for a timeout, and later release or revise that region.

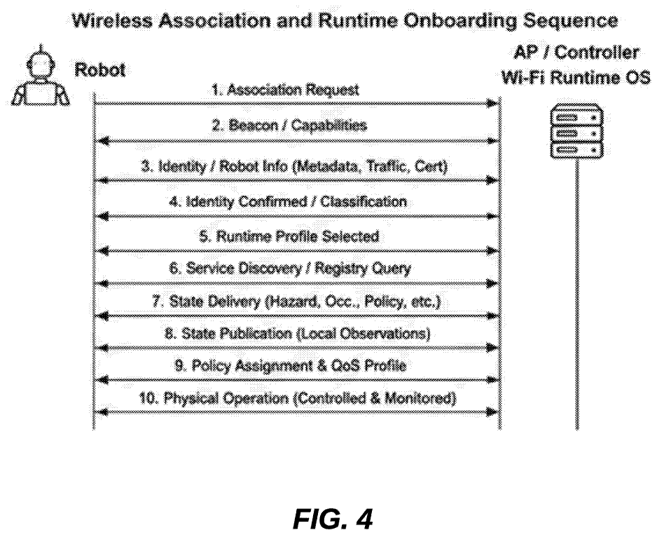

### D. Robot Identification, Onboarding, Policy, and Roaming (FIG. 4)

FIG. 4 illustrates a sequence involving a physical AI system 410, access point 420, wireless controller 430, runtime service registry 440, and local robot runtime 450. The physical AI system first transmits or causes availability of association information from a beacon, pre-association queries, discovery information, or ordinary traffic.

The access point or controller analyzes available information and generates a robot classification. Inspection may be performed on metadata alone, on packet or message content where permitted, on a combination of metadata and content, or on behavioral characteristics over time. The disclosed system does not require decryption of protected communications.

A protocol signature may include communication with a known robot server, recurring publication to a message topic, discovery traffic, a particular sequence of requests, transport port use, packet-size distribution, telemetry periodicity, or a machine-learned representation of traffic behavior. A server-resource signature may identify that the robot seeks a map server, fleet broker, inference endpoint, update service, mission server, or other dependency.

The controller may bind the classification to an application profile. The profile can cause creation of a virtual network segment, firewall rule, service endpoint, protocol gateway, bandwidth treatment, multicast group, state subscription, or physical-operation policy. The profile may be changed dynamically when classification confidence changes or when explicit credentials become available.

The service registry 440 returns available runtime services. The local runtime 450 may negotiate schema versions, download or activate an adapter, receive a premises coordinate frame, obtain a permissioned state snapshot, and register supported state classes. A robot that lacks a compatible protocol may be given a minimal common service layer or routed through a translation gateway.

Enterprise robot policy may be attached to a robot session. The robot policy can be represented as declarative rules, compiled constraints, signed profiles, executable policy modules, tokens, or another machine-readable form. The robot may acknowledge the policy, reject unsupported requirements, or enter a reduced-capability mode.

Network-level enforcement and robot-local enforcement may operate together. The controller can restrict network access, service access, bandwidth, or session continuation. The local robot may use a TrustBoundary or actuator firewall to enforce physical constraints. Network deauthentication or throttling is not required for physical safety and, in some embodiments, is avoided where loss of communication could increase risk.

When a robot moves from a first access point to a second access point, the runtime preserves a session identifier and transfers or re-resolves relevant service state. The robot may receive a new local state slice, hazard set, occupancy region, and policy profile. Existing reservations can be transferred, split, revalidated, or released. The controller may preload state associated with a predicted destination cell.

Roaming can trigger a physical policy transition. For example, a robot may move from an industrial workcell to a human-facing lobby. The runtime can change maximum speed, required clearance, allowed manipulation, traffic priority, publication rights, and trust requirements. The transition can occur based on access-point association, estimated location, geofence, mission state, or combinations thereof.

A robot may leave the network or premises. The runtime may revoke service tokens, terminate subscriptions, release reservations, preserve a limited audit record, and mark state published by the robot according to an expiration or continued-validity policy. A temporary adapter may be disabled or deleted after departure.

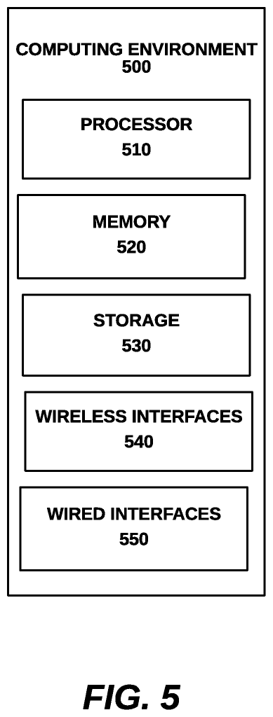

### E. WI-FI Operating System Computing Environment (FIG. 5)

FIG. 5 illustrates a computing environment 500 (e.g., an access point or Wi-Fi controller) including one or more processors 510, memory 520, storage 530, wireless interfaces 540, wired interfaces 550, and other components communicating through one or more buses or fabrics.

The processors 510 may include general-purpose processors, network processors, digital signal processors, graphics processors, neural processors, programmable packet processors, field-programmable gate arrays, application-specific integrated circuits, radio processors, or combinations thereof. The memory 520 may include volatile and nonvolatile memory. The storage 530 may include local flash, solid-state storage, remote storage, or distributed state stores.

The runtime components may execute in an access-point operating system, controller operating system, container, virtual machine, network function, microservice, kernel module, user-space service, programmable data plane, edge application, cloud service, or combinations thereof. A function described as executing at an access point may execute directly on access-point hardware or on a nearby compute service logically associated with the access point.

The environment may be centralized, hierarchical, peer-to-peer, or hybrid. An access point may operate independently, multiple access points may share a distributed state store, a controller may coordinate an enterprise domain, and a SaaS platform may synchronize multiple sites. Local safety-relevant services may continue when cloud access is unavailable.

Although Wi-Fi is emphasized, disclosed service abstractions may be used in continuations or embodiments employing private cellular, Ethernet, time-sensitive networking, ultra-wideband, Bluetooth, mesh, optical, satellite, industrial wireless, or other communications. Such alternatives do not alter the Wi-Fi-focused character of the present application.

### II. METHODS

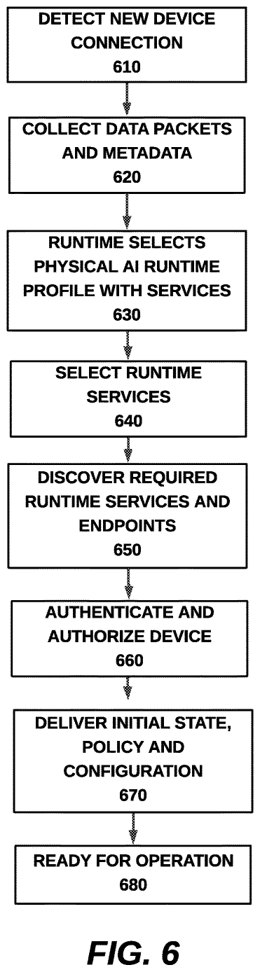

### A. Identifying and Onboarding a Physical AI System (FIG. 6)

At step 610, a wireless device is detected through pre-association signaling, association, authentication, service discovery, packet traffic, radio presence, or another indication of availability.

At step 620, the Wi-Fi runtime analyzes identity information, metadata, traffic behavior, protocol information, server dependencies, or combinations thereof to classify the device as a physical AI system and determine a device or capability profile.

At step 630, the runtime selects a physical-AI runtime profile including available services, permissions, protocol treatment, trust class, network treatment, and physical-operation policy. An unidentified or low-confidence device may receive a restricted profile.

At step 640, the runtime provides a service descriptor and establishes access to selected runtime services. The physical AI system may download or activate an adapter, register supported state types, receive a premises coordinate frame, and obtain a permissioned state snapshot.

At step 650, the runtime monitors the session and updates classification, permissions, service assignments, or policy based on explicit credentials, observed behavior, location, mission, or trust changes.

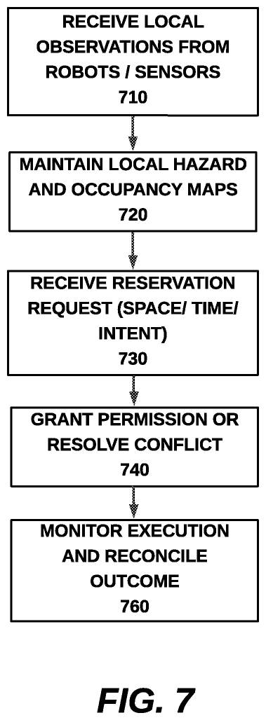

### B. Maintaining Local Physical State and Reservations (FIG. 7)

At step 710, an access point obtains state associated with a physical coverage region from robots, infrastructure sensors, a controller, an edge service, or a prior local state store.

At step 720, the access point maintains typed hazard, occupancy, intention, reservation, infrastructure, or policy objects with source, time, confidence, location, and validity

### Information.

At step 730, the access point receives a request to occupy or use a physical region or resource during a requested interval and determines whether the request conflicts with current or predicted occupancy, another reservation, a hazard,

### Or an Enterprise Policy.

At step 740, the access point grants, denies, modifies, or reschedules the request and publishes a corresponding reservation or route constraint to affected robots. The grant may define a lease, geometric envelope, time interval, priority, and release condition.

At step 750, the access point monitors participant connectivity and physical progress, and releases, transfers, extends, or revokes the reservation responsive to entry, completion, departure, missed heartbeat, disconnection, expiration, or changed physical state.

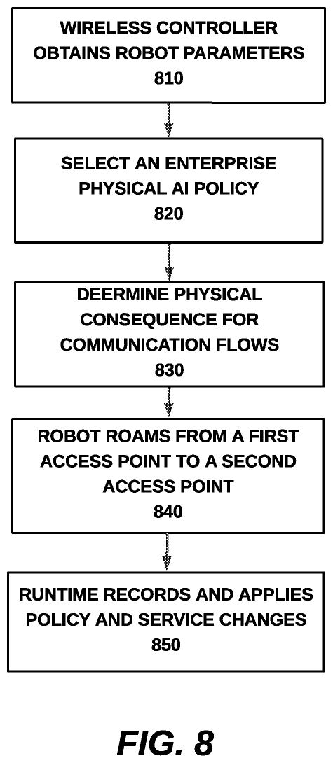

### C. Enterprise Policy and Physical-Risk Communication Treatment (FIG. 8)

At step 810, a wireless controller obtains a robot identity, role, mission, location, payload, current physical state, and communication-flow classification.

At step 820, the controller selects an enterprise physical-AI policy defining one or more physical operating constraints, service permissions, state-publication rights, infrastructure permissions, trust requirements, or supervision requirements.

At step 830, the controller determines a physical consequence associated with delay, loss, modification, or unauthorized delivery of a communication flow and assigns a corresponding communication treatment.

At step 840, the robot roams from a first access point to a second access point, and the runtime preserves identity and trust context while updating a local state view, reservation context, enterprise policy, and communication treatment for the second physical coverage region.

At step 850, the runtime records policy and service changes and causes the robot or a local enforcement component to govern a physical operation according to the updated policy.

### D. Local Continuity During Network Partition

An access point may detect loss or degradation of connectivity to a wireless controller, edge service, or cloud platform. Responsive to the condition, the access point enters a local continuity mode based on a cached policy.

In local continuity mode, the access point may continue serving currently authenticated robots, preserve active hazard and occupancy state, maintain or conservatively restrict existing reservations, reject new high-risk participants, and prevent expansion of local physical rights beyond a defined limit.

The access point records state changes in a local ordered log. When upstream connectivity returns, the access point exchanges version information, identifies conflicting updates, reconciles local and enterprise state, and distributes invalidations or revised state to affected robots.

If a robot loses its access-point connection, the runtime may immediately or after a bounded grace interval release reservations, mark the robot occupancy as uncertain, broadcast a vacated or uncertain-space event, and preserve a conservative physical region until another source confirms clearance.

### III. Generalities

The term operating system is used functionally to describe a runtime platform that manages services, participants, policies, state, events, resources, and lifecycle for physical AI systems. The Wi-Fi runtime operating system need not replace an operating system installed on a robot, access point, controller, server, or other device.

A service may be implemented as a process, daemon, module, network function, application, container, virtual machine, library, endpoint, protocol, programmable pipeline, hardware block, firmware component, or distributed combination thereof. A service may be invoked by API, message, query, subscription, event, packet, shared memory, remote procedure call, or another interface.

Identification does not require determination of a unique legal identity. Identification may include classification into a robot type, device class, protocol family, capability class, trust class, mission class, or service-needs profile. Identification may be probabilistic and may be revised over time.

Packet inspection includes inspection of packet metadata, headers, payloads, message structures, flow statistics, timing, packet size, destination, certificate, service discovery, encrypted-flow characteristics, or combinations thereof. Inspection may be performed where authorized and consistent with applicable privacy and security requirements.

A physical coverage region may correspond to actual radio coverage, a selected portion of radio coverage, a mapped premises region, a logical zone, a geofence, an infrastructure resource, or a dynamically determined region. Multiple access points may jointly serve one physical region, and one access point may serve multiple logical physical regions.

A state model may be a world model, scene graph, map, object store, digital twin, context graph, database, memory structure, collection of typed objects, or another machine-readable representation. A state model may preserve current, historical, predicted, intended, or reserved state.

A permissioned state view may omit, abstract, aggregate, transform, redact, reduce, or delay state based on identity, role, mission, location, privacy, trust, or policy. Different robots in the same wireless cell may receive different state views.

A reservation may concern space, time, a physical resource, infrastructure access, tool use, charging, manipulation, communication, or a combination thereof. A reservation can be exclusive, shared, conditional, prioritized, revocable, preemptible, or advisory.

Physical-risk-aware quality of service may be applied independently of conventional application categories. A communication flow associated with a low-bandwidth safety message may receive higher treatment than a high-bandwidth perception stream. Treatment may be revised as physical conditions change.

Network enforcement may include authentication, authorization, segmentation, filtering, rate control, service exposure, session revocation, traffic treatment, routing, proxying, or quarantine. Physical enforcement may include a local robot policy, TrustBoundary, predictive validator, actuator firewall, hardware interlock, or other component. Either may be used alone or in combination.

The disclosed system may be used in factories, warehouses, hospitals, airports, campuses, offices, retail facilities, homes, construction sites, public spaces, roads, ports, mines, farms, entertainment venues, and other environments.

Components and steps may be reordered, combined, subdivided, omitted, or distributed. References to causing an operation include directly issuing an instruction, changing a policy or state consumed by another component, granting or withholding a service, generating a reservation, modifying a communication treatment, or generating an authorization used by a local controller.

Features described in connection with one embodiment may be combined with features of another embodiment. Singular terms include plural implementations and plural terms include singular implementations where appropriate. The words including and comprising are open-ended.

What is claimed is:

1. An access point configured to provide a shared world model to a plurality of physical artificial intelligence systems during respective wireless associations, comprising:
one or more wireless transceivers configured to provide wireless connectivity within a radio coverage region associated with a physical operating region;
a physical artificial intelligence discovery service configured to detect a wireless device communicating through the access point and determine, based at least partly on wireless-association information or network-traffic characteristics, that the wireless device comprises a physical artificial intelligence system;
a profiling service configured to determine a physical-artificial-intelligence profile identifying at least one of a robot class, physical capability, robot communication protocol, server dependency, supported world-state representation, or physical-risk class; and
a runtime manager configured to:
maintain a shared world model representing the physical operating region;
receive respective world-state contributions from a plurality of physical artificial intelligence systems during temporally separate wireless associations with the access point;
retain, after termination of a first wireless association with a first physical artificial intelligence system, a world-state contribution received from the first physical artificial intelligence system; and
during a later wireless association with a second physical artificial intelligence system, provide to the second physical artificial intelligence system world-state information derived from the retained world-state contribution,
wherein the second physical artificial intelligence system uses the world-state information to modify a route, speed, candidate physical action, physical-space reservation, manipulation operation, task operation, or actuation-validation operation within the physical operating region.

2. The access point of claim 1, wherein the runtime manager is further configured to receive, from the second physical artificial intelligence system during the later wireless association, an update to the shared world model and persist the update for delivery to a subsequently associated physical artificial intelligence system.

3. The access point of claim 1, wherein the shared world model comprises semantic state objects representing physical entities, hazards, occupancy, reservations, infrastructure, robot intentions, or predicted physical condition.

4. The access point of claim 1, wherein the shared world model comprises an access-point-local state model including at least one hazard object and at least one occupancy object or reservation object associated with the physical operating region.

5. The access point of claim 1, further comprising or communicating with a Wi-Fi controller configured to manage a plurality of access points, wherein, responsive to roaming of the physical artificial intelligence system between the access point and another access point, the Wi-Fi controller causes transfer of at least one of robot state, world-model state, profile state, policy state, subscription state, or reservation state between runtime services associated with the access points.

6. The access point of claim 1, wherein the runtime manager further provides a shared-space service configured to:
receive a request by the physical artificial intelligence system to occupy a geometrically defined physical region during a time interval;
determine whether the request conflicts with occupancy or reservation state in the shared world model;
grant a time-bounded and geometrically scoped physical-space authorization that is distinct from permission to communicate through the access point; and
release or revoke the physical-space authorization responsive to disconnection, expiration, failure to enter the physical region, departure from the physical operating region, or a change in the shared world model.

7. The access point of claim 1, wherein the runtime manager further provides a hazard-warning service configured to provide hazard state from the shared world model to the physical artificial intelligence system responsive to wireless association, movement of the physical artificial intelligence system toward a region represented by the hazard state, or a change in the hazard state.

8. The access point of claim 1, wherein the runtime manager further provides a shared-task service configured to maintain a shared task-state object identifying a physical task, a physical object or region associated with the physical task, two or more participant roles, respective capability requirements for the participant roles, and a task-execution state, and to provide the shared task-state object to physical artificial intelligence systems having profiles satisfying the respective capability requirement.

9. The access point of claim 1, wherein the runtime manager is further configured to associate a world-state contribution with at least one of a source identity, observation time, receipt time, confidence value, validity interval, spatial extent, semantic classification, authority class, state version, sensor class, or provenance record.

10. The access point of claim 1, wherein the runtime manager is further configured to generate different permissioned views of the shared world model for different physical artificial intelligence devices based on at least one of a respective physical artificial intelligence profile, identity, role, capability, trust level, mission, location, communication protocol, or requested physical operation.

11. A computer-implemented method performed by wireless network infrastructure for providing a shared world model to physical artificial intelligence systems, the method comprising:
providing, by a wireless access point, wireless connectivity within a radio coverage region associated with a physical operating region;
detecting a first wireless device communicating through the wireless access point;
determining, based at least partly on wireless-association information or network-traffic characteristics associated with the first wireless device, that the first wireless device comprises a first physical artificial intelligence system;
determining a first physical artificial intelligence profile identifying at least one of a robot class, physical capability, robot communication protocol, server dependency, supported world-state representation, or physical-risk class;
receiving, during a first wireless association with the first physical artificial intelligence system, a first world-state contribution representing physical state associated with the physical operating region;
updating a shared world model based on the first world-state contribution;
retaining at least part of the first world-state contribution after termination of the first wireless association;
detecting a second physical artificial intelligence system during a later wireless association with the wireless access point;
providing, to the second physical artificial intelligence system, world-state information derived from the retained first world-state contribution; and
causing the second physical artificial intelligence system to modify a physical operation within the physical operating region based on the world-state information.

12. The method of claim 11, wherein the first world-state contribution comprises at least one semantic state object representing a hazard, occupancy, physical-space reservation, infrastructure condition, robot intention, physical resource, human presence, object state, task state, or predicted physical condition.

13. The method of claim 11, further comprising:
receiving, from the second physical artificial intelligence system, a second world-state contribution comprising a corroboration, contradiction, update, invalidation, or newly observed physical state; and
updating the shared world model based on the second world-state contribution for delivery to a subsequently associated physical artificial intelligence system.

14. The method of claim 11, further comprising:
determining a profile of the second physical artificial intelligence system; and
selecting, based on the profile, a schema, semantic abstraction level, coordinate representation, communication protocol, or permissioned view in which the world-state information is provided to the second physical artificial intelligence system.

15. The method of claim 11, further comprising:
receiving, from the second physical artificial intelligence system, a request to occupy a geometrically defined physical region during a requested time interval;
determining whether the request conflicts with occupancy state, reservation state, hazard state, or predicted physical state represented in the shared world model;
granting, responsive to an absence of a disqualifying conflict, a time-bounded and geometrically scoped physical-space authorization distinct from permission to communicate through the wireless access point; and
releasing, modifying, or revoking the physical-space authorization responsive to disconnection, expiration, failure to enter the geometrically defined physical region, departure from the physical operating region, or a change in the shared world model.

16. The method of claim 11, further comprising:
detecting roaming of the second physical artificial intelligence system between the wireless access point and another wireless access point; and
transferring, preloading, or re-resolving at least one of robot state, shared-world-model state, profile state, policy state, subscription state, hazard state, task state, or reservation state for use through the other wireless access point.

17. The method of claim 11, further comprising:
determining a physical consequence associated with delay, loss, corruption, or staleness of a communication flow carrying an update to the shared world model; and
assigning, based on the physical consequence, a communication priority, reliability mode, airtime allocation, transmission schedule, redundancy treatment, retransmission treatment, or bounded-staleness requirement to the communication flow.

18. The method of claim 11, further comprising:
detecting loss of connectivity between the wireless access point and an upstream controller, edge service, or cloud service;
continuing, at the wireless access point, to provide the shared world model from a local state store;
restricting admission of new physical artificial intelligence systems or granting of new physical-space authorizations according to a cached continuity policy;
recording local world-state updates during the loss of connectivity; and
reconciling the local world-state updates with an upstream shared world model after connectivity is restored.

19. A non-transitory computer-readable medium storing instructions that, when executed by one or more processors of wireless network infrastructure, cause the one or more processors to:
operate a wireless access point providing wireless connectivity within a radio coverage region associated with a physical operating region;
detect wireless devices communicating through the wireless access point;
classify at least a subset of the wireless devices as physical artificial intelligence systems based at least partly on wireless-association information or network-traffic characteristics;
determine respective physical artificial intelligence profiles for the physical artificial intelligence systems;
maintain, across temporally separate wireless associations of the physical artificial intelligence systems, a shared world model representing the physical operating region;
receive world-state contributions from the physical artificial intelligence systems during the temporally separate wireless associations;
retain a first world-state contribution received from a first physical artificial intelligence system after termination of a wireless association with the first physical artificial intelligence system;
provide, during a later wireless association with a second physical artificial intelligence system, world-state information derived from the retained first world-state contribution; and
provide the world-state information in a form usable by the second physical artificial intelligence system to modify a route, speed, candidate physical action, physical-space reservation, manipulation operation, cooperative task, infrastructure interaction, or actuation-validation operation.

20. The non-transitory computer-readable medium of claim 19, wherein the instructions further cause the one or more processors to:
associate respective world-state contributions with source, time, confidence, validity, location, authority, version, and provenance information;
generate a permissioned shared-world-model view based on a profile of a receiving physical artificial intelligence system;
expire, supersede, reconcile, quarantine, or retain conflicting world-state contributions;
select or instantiate a protocol adapter for the receiving physical artificial intelligence system; and
provide the permissioned shared-world-model view through the selected or instantiated protocol adapter.
